(19) United States
(12) Patent Application Publication
(10) Pub. No.: US 2004/0235553 A1
(43) Pub. Date: Nov. 25, 2004

(54) Gaming machine and gaming system with a plurality of gaming machines

(76) Inventor: Hideaki Iwamoto, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/849,426

(22) Filed: May 20, 2004

(30) Foreign Application Priority Data
May 23, 2003 (JP) JP2003-146736
May 23, 2003 (JP) JP2003-146766
May 30, 2003 (JP) JP2003-154211

(51) Int. Cl. A63F 13/00

(52) U.S. Cl. 463/16

(57) ABSTRACT

It is disclosed the gaming machine which is constructed so that the second game is selected in relation to the effect information of the base game and it can be judged if there is a chance to shift to which kind of the bonus game, based on the effect information in the base game. In the progressive gaming system 82, it is constructed so that when the common bonus is won in the slot machine 1, the progressive unit 83 transmits to each slot machine 1 through the transmission control part 84 the coin pool information every each progressive bonus concerning with the bonus game, and such coin pool information is displayed on the upper liquid crystal display 3 in the slot machine 1, and further if payout of coins for the common bonus which is won is determined, the common bonus (gold bar, jewelry, crown) concerning with the bonus game (bank bonus game, jewelry shop bonus game, royal museum bonus game) is selected and paid out.

### CROSS-REFERENCE TO THE RELATED APPLICATION (S)

This application is based upon and claims a priority from the prior Japanese Patent Application Nos. 2003-146736 filed on May 23, 2003, 2003-146766 filed on May 23, 2003 and 2003-154211 filed on May 30, 2003, the entire contents of which are incorporated herein by reference.

### BACKGROUND OF THE INVENTION

1. Field of the Invention

The present invention relates to a gaming machine in which a base game is executed and a second game is executed continuous to the base game when a predetermined condition is realized.

And the present invention relates to a gaming system in which a plurality of gaming machines and a control unit are connected with each other. In particular, the present invention relates to a gaming system in which a predetermined proportion of wager betted in each gaming machine is accumulated in the control unit as a common bonus and a payout is awarded from the common bonus when a predetermined condition is realized while a game is conducted in the gaming machine.

2. Description of Related Art

Conventionally, there are proposed various gaming machines in which, based on that a predetermined condition is realized while the first game is conducted, the second game more beneficial for a player than the first game is successively conducted continuous to the first game.

For example, in Japanese Unexamined Publication No. 2001-293248, it is disclosed a gaming machine that a free game in beginning series for giving twice payout of a pay table in a base game is conducted when a predetermined condition is triggered during the base game on the display and further a continuous free game with bonus feature having triple payout in comparison with the pay table in the base game can be done when it occurs the same condition as in the above condition in the free game in beginning series.

Further, there exists a gaming machine that a plural kinds of second games, each of which is successively conducted to the first game done at first and has game contents and payout different from with each other, are installed therein, and one of the second games is selected and executed based on that a predetermined condition is realized during the first game.

However, it is very hard to make the player grasp various game contents of the second games during the first game. And it cannot make the player judge if there is a chance to shift to which kind of the second game before the first game is finished. As a result, expectation to the second game cannot help becoming thin for the player.

Further, conventionally, it is proposed a gaming system in which a plurality of gaming machines and a control unit are connected and a predetermined proportion of wager (betted wager) in each gaming machine is accumulated as a common bonus in the control unit, and based on that a specific winning condition is realized in any gaming machine, coins and the like are paid out in such gaming machine from the common bonus accumulated in the control unit.

For instance, in U.S. Pat. No. 4,837,728, it is disclosed a game system in which a plurality of slot machines and a progressive controller are connected, and in this game system, a predetermined proportion of wager betted in each slot machine is divided by a predetermined ratio every symbol constructing the winning combinations in the slot machine and the divided wager is accumulated as the common bonus while adding to an initial value every symbol, thereby the wager of the accumulated common bonus every symbol is displayed on a display device. Further, when the predetermined winning combination is won in any of the slot machines, the accumulated wager is paid out from the common bonus corresponding to the symbol constructing the winning combination.

However, in the game system disclosed in U.S. Pat. No. 4,837,728, when the winning combination is won in the slot machine, although the player can confirm the payout sum from the common bonus by comparing the symbol corresponding to the winning combination with the common bonus every symbol displayed on the display device, the player cannot judge if there is a chance to get the common bonus for which kind of winning combination before the game in the slot machine is finished, because the player can first understand winning of the winning combination at the time that each symbol is stopped. Therefore, while gaming in the slot machine, expectation to get each common bonus cannot help becoming thin and interest for games cannot be highly maintained.

And in the above mentioned gaming system, although it is constructed so that game information in one of the slot machines is notified to the other slot machine, the player cannot judge if there is a chance to get the common bonus for which kind of winning combination before the game in the slot machine is finished. Also, as for this point, the same situation exists for the player of the other slot machine and gallery.

Further, in the game system disclosed in U.S. Pat. No. 4,837,728, if it regards as important to transmit information concerning with the common bonus to each slot machine by real time, information transmittable to each slot machine from the progressive controller is limited to a little information such as payout information concerning with the common bonus and the like.

Here, as information transmitted to each slot machine from the progressive controller in the above mentioned game system, there are raised payout information of the common bonus and reset information which is transmitted when the common bonus is won.

Therefore, although the player of the slot machine in which the common bonus is won can justly confirm the fact that the common bonus is won at that time, it is very difficult that the player of the other slot machine and gallery judges when the common bonus is won and got. Thereby, expectation and interest for the common bonus becomes thin, as a result, interest for games cannot be maintained.

### SUMMARY OF THE INVENTION

The present invention has been done to resolve the above mentioned problems and has an object to provide a gaming machine through which the player can have expectation for the second game while the base game is done, thereby interest of the player for games can be highly maintained.

And the present invention has an object to provide a gaming system in which the player of any one of gaming machines, the players of the other gaming machines and gallery can easily determine if there is a chance to get which kind of the common bonus, even before game conducted in any of gaming machines is finished.

The present invention has been done to resolve the above objects and according one aspect of the present invention, it is provided a gaming machine in which a base game is executed and a second game is executed continuous to the base game when a predetermined condition is realized, the gaming machine comprising:

a display device;

a memory for storing a plural kinds of effect information for the base game;

an effect information select device for selecting one effect information from the memory when the base game is executed;

a display control device for controlling the display device to display the effect information of the base game, the effect information being selected by the effect information select device;

a judgement device for judging whether the predetermined condition is realized or not;

a game control device for selecting one second game from a plural kinds of the second games in relation to the effect information of the base game selected by the effect information select device when it is judged by the judgement device that the predetermined condition is realized and for executing the selected second game after the effect information of the base game is displayed on the display device by the display control device.

According to the gaming machine, one effect information is selected by the effect information select device among a plural kinds of effect information stored in the memory when the base game is executed and the selected effect information is displayed on the display device under control by the display control device. And when it is judged by the judgement device that the predetermined condition is realized, one second game is selected by the control device from a plural kinds of the second games in relation to the effect information of the base game selected by the effect information select device and the selected second game is executed after the effect information of the base game is displayed on the display device by the display control device. Therefore, in the second game, effect developed so as to tell a story from the effect information in the base game can be conducted. Thereby, contents of the second game can be easily grasped based on the effect information of the base game.

Further, since the second game is selected in relation to the effect information of the base game, the player can judge if there is a chance to shift to which kind of the second game, based on the effect information in the base game. Therefore, it can make the player have expectation for the second game while conducting the base game and interest of the player for games can be highly maintained.

According to another aspect of the present invention, it is provided a gaming system including:

a plurality of gaming machines each of which selects one game among a plurality of games and executes the selected game; and

a control unit to which each gaming machine is connected, the control unit dividing a predetermined proportion of wager betted in each gaming machine by a predetermined ratio and accumulating each divided wager as a common bonus which has a relation to each game;

wherein the control unit controls the display device so as to display information concerning with the game conducted in the gaming machine and the common bonus, and

wherein the gaming machine pays out the common bonus based on that a specific condition corresponding the game is realized.

According to the above constructed gaming system, the control unit controls the display device so as to display information concerning with the game conducted in the gaming machine and the common bonus having a relation to each game and the gaming machine pays out the common bonus accumulated in the control unit corresponding to the game based on that a specific condition is realized in the game. Therefore, before the game conducted in any one of the gaming machines is finished, the player of the gaming machine, the other players and gallery can easily confirm if there is a chance to be able to get which kind of the common bonus. Thereby, while the game is conducted in the gaming machine, expectation to get various common bonuses can be increased and interest for games can be raised.

Here, in concept of the game, it is included a base game and a bonus game progressively conducted continuous to the base game.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view of the slot machine,

FIG. 2 is a longitudinal sectional view of a lower liquid crystal display and a reel,

FIG. 3 is an exploded perspective view of the lower liquid crystal display, in which FIG. 3A shows a transparent touch panel, FIG. 3B shows a reel glass plate, FIG. 3C shows a bezel metal frame, FIG. 3D shows a transparent liquid crystal panel, FIG. 3E shows a liquid crystal holder, FIG. 3F shows a scattering sheet, FIG. 3G shows a light leading plate, FIG. 3H shows a white reflector, FIG. 3I shows a rear holder and FIG. 3J shows an antistatic sheet,

FIG. 4 is an explanatory view schematically showing symbols formed on an outer periphery of the reel,

FIG. 5 is a block diagram showing control system of the slot machine,

FIG. 6 is an explanatory view schematically showing a progressive gaming system,

FIG. 7 is an explanatory view schematically showing background images displayed on the lower liquid crystal display when a base game is conducted,

FIG. 8 is an explanatory view schematically showing background images displayed on the lower liquid crystal display when the base game is conducted,

FIG. 9 is an explanatory view schematically showing background images displayed on an upper liquid crystal display and the lower liquid crystal display when a pickpocket bonus game is conducted,

FIG. 10 is an explanatory view schematically showing background images displayed on the upper liquid crystal display and the lower liquid crystal display when a bank bonus game is conducted,

FIG. 11 is an explanatory view schematically showing background images displayed on the upper liquid crystal display and the lower liquid crystal display when a jewelry shop bonus game is conducted,

FIG. 12 is an explanatory view schematically showing background images displayed on the upper liquid crystal display and the lower liquid crystal display when a first mission of a royal museum bonus game is conducted,

FIG. 13 is an explanatory view schematically showing background images displayed on the upper liquid crystal display and the lower liquid crystal display when a second mission of the royal museum bonus game is conducted,

FIG. 14 is an explanatory view schematically showing background images displayed on the upper liquid crystal display and the lower liquid crystal display when a final mission of the royal museum bonus game is conducted, and

FIG. 15 is a flowchart showing gaming procedures conducted in the slot machine.

### DETAILED DESCRIPTION OF THE PREFERRED EMBODIMENTS

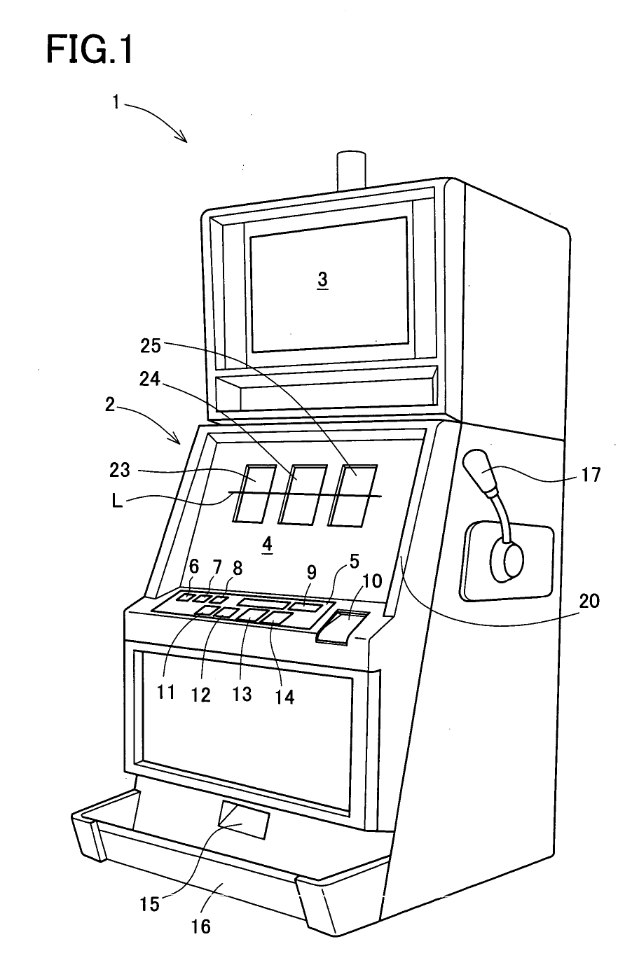

Hereinafter, the gaming machine according to the present invention will be described according to the embodiment embodying the invention, with reference to the drawings. First, an outline construction of the gaming machine according to the embodiment will be described with reference to FIG. 1. Here, in the embodiment, the slot machine as an example of the gaming machine will be explained. FIG. 1 is a perspective view of the slot machine.

In FIG. 1, the slot machine 1 has a cabinet 2 constructing a whole of the slot machine 1. At a front upper part of the cabinet 2 an upper liquid crystal display 3 is arranged, and at a front central part of the cabinet 2 a lower liquid crystal display 4 is arranged. Here, the upper liquid crystal display 3 is constructed from a liquid crystal display device which is generally used, and the lower liquid crystal display 4 is constructed from, so-called, a transparent liquid crystal display device. A detailed construction of the transparent liquid crystal display device will be explained hereinafter.

An operation table 5, which is projected frontward, is formed below the lower liquid crystal display 4, and from the most left side on the operation table 5, a change button 6, a payout (cash out) button 7, a help button 8 are arranged. And a coin insertion slot 9 and a bill insertion portion 10 are arranged at the right side of the help button 8. Further, from the left side, a 1-BET button 11, a SPIN/REPEAT BET button 12, a 3-BET button 13 and a 5-BET button 14 are positioned at the front side on the operation table 5.

Here, the change button 6 is pressed when exchanging the bill inserted in the bill insertion portion 11, and the exchanged coins are paid out through a coin payout hole 15 to a coin tray 16 which is formed at the lower part of the cabinet 2. To the change button 6, a change switch 62 (explained hereinafter) is attached, and the a switch signal is output to a CPU 50 (mentioned hereinafter) from the change switch 62 based on press of the change button 6.

The payout button 7 is usually pressed when games are terminated, and when the payout button 7 is pressed coins got in games are paid out through the coin payout hole 15 to the coin tray 16. Here, to the payout button 7, a payout (cash out) switch 63 (mentioned hereinafter) is attached and a switch signal is output to the CPU 50 from the payout switch 63 based on press of the payout button 7.

The help button 8 is pressed when the player cannot understand game operation method, and when the help button 8 is pressed, various help information is displayed on the upper liquid crystal display 3 or the lower liquid crystal display 4. To this help button 8, a help switch 64 (mentioned hereinafter) is attached and a switch signal is output to the CPU 50 from the help switch 64 based on press of the help button 8.

To the coin insertion slot 9 a coin sensor 65 (mentioned hereinafter) is positioned, and when the coin is inserted in the coin insertion slot 9 a coin detection signal is output to the CPU 50 through the coin sensor 65. And to the bill insertion portion 10 a bill sensor 66 (mentioned hereinafter) is positioned, and when the bill is inserted in the bill insertion portion 10 a bill detection signal is output to the CPU 50 through the bill sensor 66.

As for the 1-BET button 11, every the 1-BET button 11 is pressed one credit is betted, and the 1-BET button 11 can bet by pressing up to tree times as the maximum pressing time. To the 1-BET button 11, a 1-BET switch 59 is attached and when the 1-BET button 11 is pressed a switch signal is output to the CPU 50 from the 1-BET switch 59 based on press of the 1-BET button 11.

The SPIN/REPEAT BET button 12 is the button to start games from the present bet number or the previous bet number by press thereof, thereby reels (mentioned later) are started to rotate. To the SPIN/REPEAT BET button 12, a spin switch 58 (mentioned later) is attached, and when the SPIN/REPEAT BET button 12 is pressed a switch signal is output to the CPU 50 from the spin switch 58 based on press of the SPIN/REPEAT BET button 12. Here, as the bet number which can be betted by press of the SPIN/REPEAT BET button 12, there may exist 1, 2, 3 and 5 bets.

The 3-BET button 13 is the button to start games from 3 bets on the basis of press thereof. To this 3-BET button 13, a 3-BET switch 60 (mentioned hereinafter) is attached and when the 3-BET button 13 is pressed a switch signal is output to the CPU 50 from the 3-BET switch 60. And the 5-BET button 14 is the button to start games from 5 bets on the basis of press thereof or to be pressed when a bonus game (mentioned hereinafter) is started. To the 5-BET button 14, a 5-BET switch 61 is attached and when the 5-BET button is pressed a switch signal is output to the CPU 50 from the 5-BET switch 61 on the basis of press thereof.

Further, at the lower part of the cabinet 2, the coin payout hole 15 is formed and the coin tray 16 to receive coins paid out from the coin payout hole 15 is provided. In the coin payout hole 15, a coin detection part 73 constructed from a sensor and the like is positioned and the coin detection part 73 detects number of coins paid out from the coin payout hole 15.

Further, at the side plane (the right side plane in FIG. 1) of the cabinet 2, a start lever 17 is arranged rotatably within a predetermined angle range. To the start lever 17, a start switch 57 is attached and when the start lever 17 is rotated a switch signal occurring from the start switch 57 is output to the CPU 50.

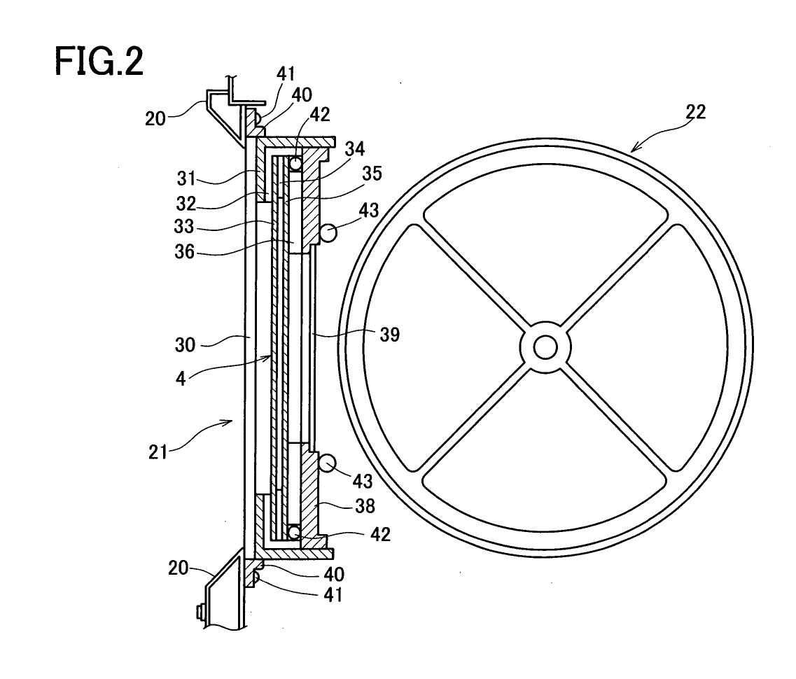

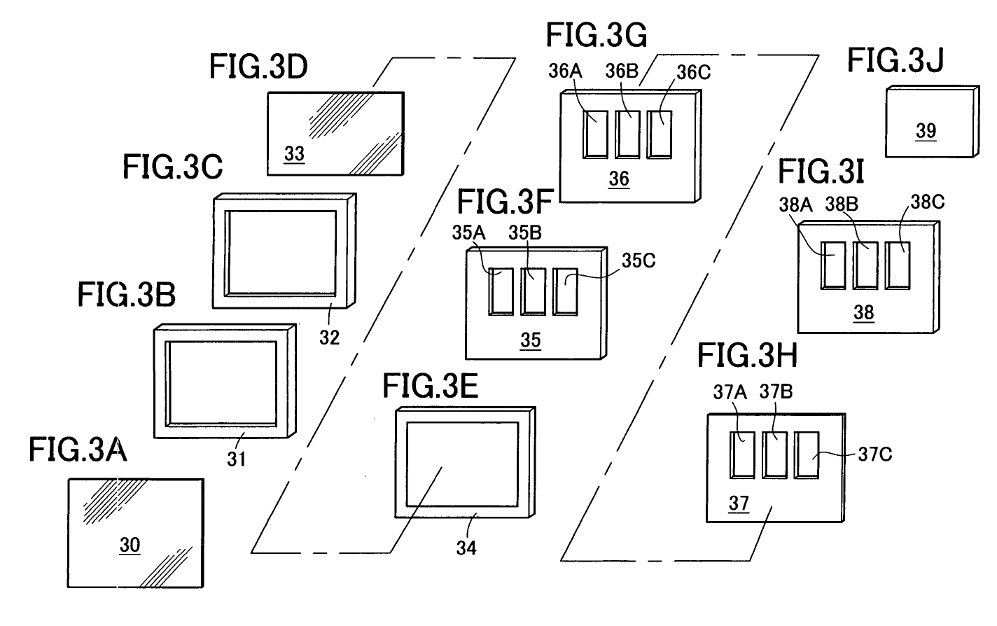

Next, it will be described a detailed construction of the lower liquid crystal display 4 and reels rotatably arranged behind the lower liquid crystal display 4 in the cabinet 2, with reference to FIGS. 2 and 3. FIG. 2 is a longitudinal sectional view of the lower liquid crystal display and the reels, and FIG. 3 is an exploded perspective view of the lower liquid crystal display 4.

In FIGS. 2 and 3, the lower liquid crystal display 4 is arranged within a display window 21 of a device front panel 20 positioned at the front center part of the cabinet 2 in the slot machine 1, with a touch panel 30 arranged at the front side (the left side in FIG. 2) of the lower liquid crystal display 4. And at the rear side (the right side in FIG. 2) of the lower liquid crystal display 4, three reels 22 (only one reel 22 is indicated in FIG. 2) are supported in a parallel state so that the reels 22 become independently rotatable.

Here, each reel 22 will be described. Among three reels 22, the left reel 22 when seeing the front plane of the slot machine 1 faces to a left display window 23 (see FIG. 1) formed in the lower liquid crystal display 4, the center reel 22 faces to a center display window 24 (see FIG. 1) similarly formed in the lower liquid crystal display 4 and the right reel 22 faces to a right display window 25 (see FIG. 1) similarly formed in the lower liquid crystal display 4. Construction of each of the display windows 23, 24, 25, will described hereinafter.

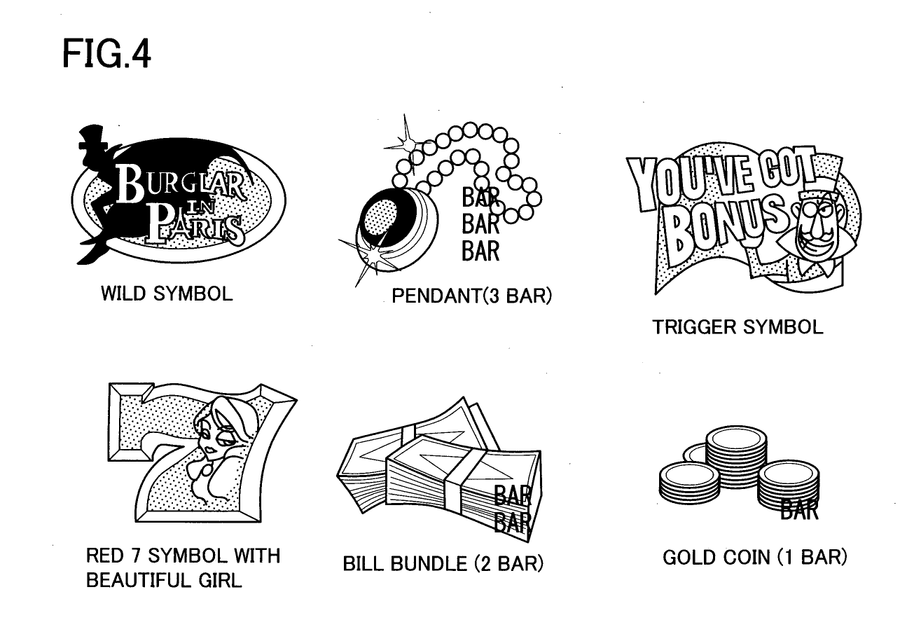

Further, on an outer periphery of each reel 22, various kinds of symbols shown in FIG. 4 (6 kinds of symbols are indicated in FIG. 4) are formed. Concretely, as kinds of symbols formed on the outer periphery of the reel 2, concerning with game contents conducted in the slot machine 1, it is utilized a wild symbol, a pendant symbol, a trigger symbol, a red 7 symbol to which a beautiful girl is attached, a bill bundle symbol and a gold coin symbol. And these 6 kinds of symbols and blank (s) (area where the symbol do not exist) are combined based on a predetermined combination and the combinations in which the symbols and the blanks are totally combined (the total number of the symbols and the blanks is 22) is formed. On the outer periphery of each reel 22, such combination with of symbols and blanks (total number of which is 22) is formed.

Here, various winning combinations are determined beforehand based on plural kinds of combinations of the symbols and when the symbol combination corresponding to the winning combination is stopped along a pay line L (see FIG. 1), coins are paid out from the coin payout hole 15 according to the winning combination. These points are as same as that in the conventional slot machine, therefore explanation thereof will be omitted. And formation of the symbols on the outer periphery of the reel 22 is generally done as follows. First, symbols and blanks (total number of which is 22) are printed on a long seal having a width and a length corresponding to the width and the periphery length of the reel 2, respectively. And such seal is adhered on the peripheral plane of the reel 22. Of course, the symbols may be formed by different method other than the above method.

In the embodiment, the pay line L is determined to only the center line, and such pay line L is displayed on the lower liquid crystal display 4 when games are conducted by rotating and stopping the reels 22 based on press of the SPIN/REPEAT BET button 12, the 3-BET button and the 5-BET button 14 or rotation of the start lever 17. On the other hand, the pay line L is eliminated from the lower liquid crystal display 4 when the bonus game is conducted based on press of the 5-BET button 14 in obtaining various bonus games.

Further, the above mentioned trigger symbol functions as a trigger to obtain various bonus games. In the embodiment, one trigger symbol is formed only on the peripheral plane of the right reel 22. Based on that the trigger symbol existing on the peripheral plane of the right reel 22 is stopped on the pay line L, various bonus games can be obtained.

Next, construction of the lower liquid crystal display 4 will be described with reference to FIGS. 2 and 3A˜3J. In FIGS. 2 and 3A˜3J, the lower liquid crystal display 4 is constructed by arranging from the front side of the slot machine 1; the transparent touch panel 30, the reel glass base 31, the bezel metal frame 32, the transparent liquid crystal panel 33, the liquid crystal holder 34, the scattering sheet 35, the light leading plate 36, the white reflector 37, the rear holder 38 and the antistatic sheet 39. In the scattering sheet 35, three openings 35A, 35B, 35C are formed. Similarly, in the light leading plate 36, the reflector 37 and the rear holder 38, three openings 36A, 36B, 36C, 37A, 37B, 37C, 38 A, 38B, 38C are formed respectively, so as to coincide with the openings 35A, 35B, 35C. Here, the openings 35A˜38A construct the left display window 23 (see FIG. 1) by superimposing so as to coincide with each other. Similarly, the openings 35B˜38B construct the center display window 24 (see FIG. 1) by superimposing so as to coincide with each other and the openings 35C˜38C construct the right display window 25 by superimposing so as to coincide with each other. Here, the openings 35A˜35C in the scattering sheet 35 and the openings 36A˜36C in the light leading plate 36 construct the light transmitting areas to retain visibility while variable displaying is conducted by rotating reels 22.

In order to install the lower liquid crystal display 4 to the display window 21 of the device front panel 20, as shown in FIG. 2, brackets 40 are screwed to the rear side of the device front panel 20 by screws 41.

And at an upper and lower end of the light leading panel 36, a pair of cathode ray tubes 42 are arranged as light sources of the liquid crystal panel 33. And at an upper and lower positions in the rear side of each of openings 38A˜38C in the rear holder 38, a pair of cold cathode ray tubes 43 are arranged to illuminate the symbols on the outer periphery of each of the reels 22.

The liquid crystal panel 33 is a transparent electric display panel on which transparent electrodes such as ITO are formed, and arranged in front of each of the reels 22 which can be seen therethrough. And the circumference in rear side of the display part of the liquid crystal panel 33 is held by the liquid crystal holder 34. The light leading plate 36 is made from the light transmitting resin panel, and in the light leading plate 36 lens cut portions are formed, the lens cut portions leading light emitted from the cold cathode ray tubes 43 positioned at side positions to the rear side of the liquid crystal panel 33. The light scattering sheet 35 is made from a light transmitting resin sheet and scatters light led by the light leading panel 36 and levels light irradiated to the liquid crystal panel 33. The liquid crystal holder 34 for holding the liquid crystal panel 33, the scattering sheet 35 and the light leading plate 36 are assembled into one body and circumference thereof is inserted in the bezel metal frame 32. Thereby, the front side of the display part in the liquid crystal panel 33 is retained by the bezel metal frame 32.

Circumference of the liquid crystal holder 34, the light scattering sheet 35 and the light leading plate 36, which are inserted in the bezel metal frame 32 and assembled into one body, is further inserted in the reel glass base 31 and retained by the reel glass base 31 in a state that the front display plane of the liquid crystal panel 33 is opened. The transparent touch panel 30 is pressed and contacted to the front side of the reel glass base 31 by installing the reel glass base 31 to the device front panel 20 through the screws 41, thereby the transparent touch panel 30 is superimposed on the front display plane of the liquid crystal panel 33.

The rear holder 38 is made from a white resin plate and retains to the reel glass base 31 the bezel metal frame 32 supported to the reel glass base 31, the liquid crystal holder 34 holding the liquid crystal panel 33, the light scattering sheet 35 and the light leading plate 36 from the rear sides thereof. The rear holder 38 also functions as a reflecting plate for reflecting light emitted from the cold cathode ray tubes 43 to the light leading plate 36 toward the liquid crystal panel 33. The antistatic sheet 39 is made transparent and adhered to the rear plane of the rear holder 38 by double-sided adhesive tape, thereby the antistatic sheet 39 covers the rear plane of each of the openings 38A˜38C formed in the rear holder 38.

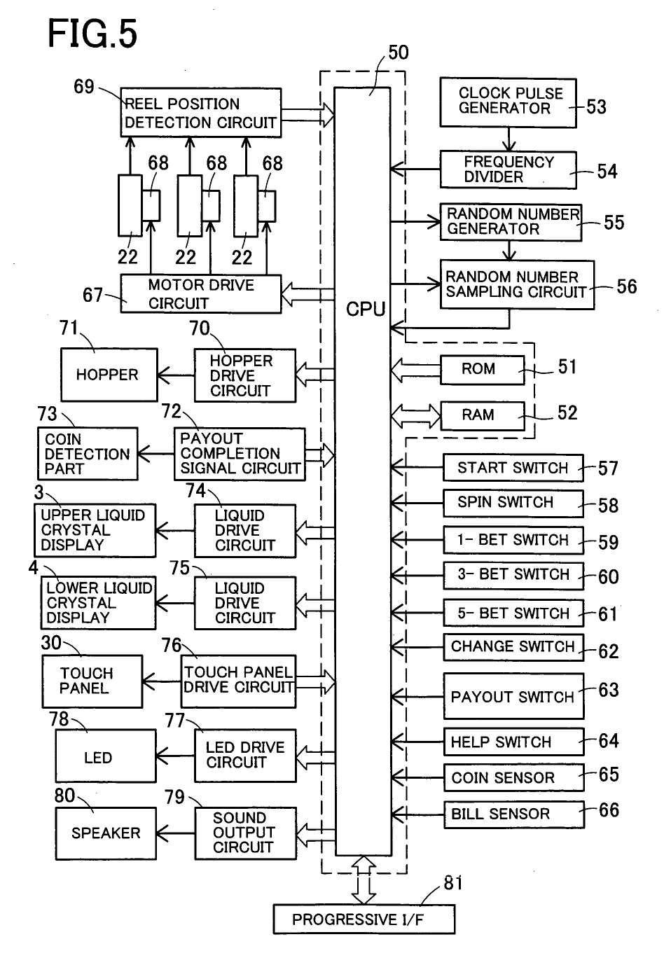

Next, construction of the control system in the slot machine 1 will be described with reference to FIG. 5. FIG. 5 is a block diagram schematically showing the control system in the slot machine 1.

In FIG. 5, the control system of the slot machine 1 is basically constructed from the CPU 50, and a ROM 51 and a RAM 52 are connected to the CPU 50. The ROM 51 stores game control program (mentioned later), various effect programs for executing various effects on the upper liquid crystal display 3 and the lower liquid crystal display 4 according to progress in games, lottery program for conducting lottery of various winning combinations, various programs necessary for controlling the slot machine 1 and various data tables and the like. And the RAM 52 is a memory for temporarily storing various data calculated by the CPU 50.

And to the CPU 50, a clock pulse generator 53 for generating standard clock pulses and a frequency divider 54 are connected, and a random number generator 55 and a sampling circuit 56 are also connected. Random number sampled by the random number generator 56 is utilized in various lotteries of the winning combinations, the effects and the like. Further, to the CPU 50, the start switch 57 attached to the start lever 17, the spin switch 58 attached to the SPIN/REPEAT BET button 12, the 1-BET switch 59 attached to the 1-BET button 11, the 3-BET switch 60 attached to the 1-BET button 13, the change switch 62 attached to the payout button 7 and the help switch 63 attached to the help button 8 are connected respectively. The CPU 50 controls the slot machine 1 to execute various operations corresponding to each button, based on the switch signal output from each switch when such buttons are pressed.

Further, to the CPU 50, the coin sensor 65 positioned in the coin insertion slot 9 and the bill sensor 66 positioned in the bill insertion portion 10 are connected respectively. The coin sensor 65 detects coins inserted from the coin insertion slot 9 and the CPU 50 calculates the number of inserted coins based on the coin detection signal output from the coin sensor 65. The bill sensor 66 detects the kind and sum of bill and the CPU 50 calculates the number of coins equivalent to sum of bill, based on the bill detection signal output from the bill sensor 66.

To the CPU 50, three stepping motors 68 for rotating each of the reels 22 through a motor drive circuit 67 are connected, and also a reel position detection circuit 69 is connected. When a motor drive signal is output to the motor drive circuit 67, each stepping motor 68 is driven to rotate by the motor drive circuit 67, thereby each reel 22 is rotated.

At that time, after each reel 22 is started to rotate, the number of drive pulses provided to each stepping motor 68 is calculated and the calculated value is written in the predetermined area of the RAM 52. And the reset pulse is output every one rotation of the reel 22 and such reset pulse is input to the CPU 50 through the reel position detection circuit 69. When the reset pulse is input to the CPU 50, the calculated value written in the RAM 52 is cleared in “0”, and the CPU 50 recognizes the symbol rotational position in the reel 22, based on the calculated value corresponding to the rotational position of the reel 22 within one rotation and the symbol table in which the rotational position of the reel 22 stored in the ROM 51 and the symbols formed on outer peripheral plane of the reel 22 are corresponded with each other.

To the CPU 50, a hopper 71 is connected through a hopper drive circuit 70. When a drive signal is output to the hopper drive circuit 70 from the CPU 50, the hopper 71 pays out predetermined number of coins from the coin payout hole 15.

And to the CPU 50, a coin detection part 73 is connected through a payout completion signal circuit 72. The coin detection part 73 is arranged in the coin payout hole 15 and when the coin detection part 73 detects that a predetermined number of coins are paid out from the coin payout hole 15, the payout completion signal is output to the payout completion signal circuit 72 from the coin detection part 73. Based on this, the payout completion signal circuit 72 outputs the payout completion signal to the CPU 50.

Further, to the CPU 50, the upper liquid crystal display 3 is connected through a liquid crystal drive circuit 74 and the lower liquid crystal display 4 is connected through a liquid crystal drive circuit 75. And to the CPU 50, the touch panel 30 is connected through a touch panel drive circuit 76.

Further, to the CPU 50 LEDs 78 are connected through a LED drive circuit 77. A plurality of the LEDs 78 are arranged on the front plane of the slot machine 1 and the LEDs 78 are controlled so as to turn on based on the drive signals from the CPU 50. Further, a speaker 80 and a sound output circuit 79 are connected to the CPU 50 and the speaker 80 produces various effective sounds when various effects are conducted based on the output signal from the sound output circuit 79.

Here, to the CPU 50, a progressive interface (I/F) 81 is provided.

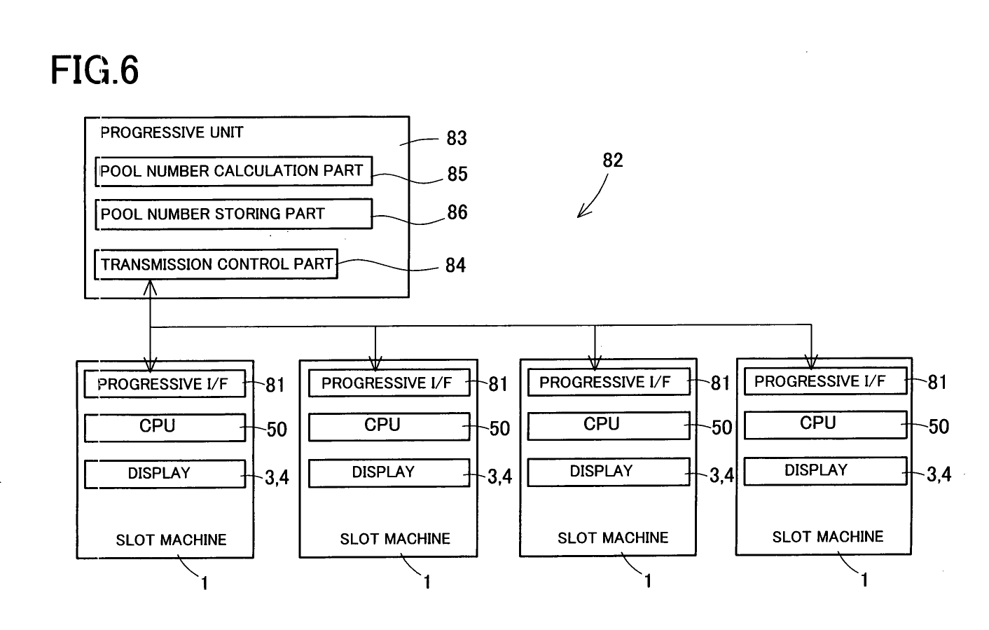

Next, it will be described a progressive gaming system in which a plurality of slot machines 1 are connected through the progressive interface (I/F) provided in each slot machine 1, with reference to FIG. 6. FIG. 6 is an explanatory view schematically showing the progressive gaming system.

In the progressive gaming unit 82 shown in FIG. 6, a plurality of slot machines 1 (in the embodiment, four slot machines 1) are connected to a transmission control part 84 in the progressive unit 83 through the progressive interface (I/F) 81 provided in each slot machine 1. As for connection between the progressive unit 83 and each slot machine 1, any one of wire connection and wireless connection can be utilized. Thereby, mutual transmission can be done through the transmission control part 84 between the progressive unit 83 and each slot machine 1.

As the information transmitted to the progressive unit 83 from each slot machine 1, coin insertion information betted in each slot machine 1, winning information when progressive bonus (gold bar in bank bonus game, jewelry (named as beauty's tear) in jewelry shop bonus game, crown (named as crown of riches) in the royal museum bonus game) is won in three bonus games of bank bonus game, jewelry shop bonus game and royal museum bonus game, mentioned later. And as information transmitted to each slot machine 1 from the progressive unit 83, pool number information of coins every each progressive bonus as the common bonus in which each of three progressive bonuses is held in common with each slot machine 1. Such pool number information of coins is transmitted from the progressive unit 83 to each slot machine 1 through the transmission control part 84 and displayed on the upper liquid crystal display 3 in each slot machine 1.

And a pool number calculation part 85 in the progressive unit 83 adds the common bonus every each progressive bonus, based on the coin insertion information transmitted from each slot machine 1. At that time, the pool number calculation part 85 adds the common bonus every progressive bonus as follows. That is, as for the progressive bonus of the gold coin, the pool number calculation part 85 sets the initial number as 100 and adds 2% of the number of inserted coins in each slot machine 1 to the initial number. As for the progressive bonus of the jewelry, the pool number calculation part 85 sets the initial number as 300 and adds 1.7% of the number of inserted coins in each slot machine 1 to the initial number. And as for the progressive bonus of the crown, the pool number calculation part 85 sets the initial number 900 and adds 1.7% of the number of inserted coins in each slot machine 1 to the initial number. According to the above, among the progressive bonuses, the payout in the progressive bonus of the crown obtained in the royal museum bonus game is the highest, and the payout in the progressive bonus of the jewelry obtained in the jewelry shop bonus game follows to the progressive bonus of the crown in order of the payout, and further the payout in the progressive bonus of the gold bar obtained in the bank bonus game follows to the progressive bonus of the jewelry in order of the payout.

Here, in each slot machine 1, in a case that any one of the progressive bonuses is won, the coin number corresponding to the common bonus won is rest to the initial number of coins. And the pool number storing part 86 stores the above mentioned coin number calculated by the pool number calculation part 85 every the common bonus.

The progressive unit 83 constructed according to the above periodically transmits from the transmission control part 84 to each slot machine 1 the coin pool number information of each common bonus stored in the pool number storing part 86. And each slot machine 1 periodically compares the coin pool number information transmitted in previous time with the coin pool number information transmitted in present time, based on the coin pool number information transmitted from the progressive unit 83. And in a case that the coin pool number in present time reduces than the coin pool number in previous time, each slot machine 1 notifies that the common bonus in which the coin pool number reduces is won. For example, if the progressive bonus of the crown (crown of riches) is won, the sentence such as “CROWN OF RICHES WAS STOLEN” is displayed on the upper liquid crystal display 3 or the lower liquid crystal display 4 of the slot machines 1 other than the slot machine 1 in which the common bonus is won.

Accordingly, even if the information transmitted from the progressive unit 83 to each slot machine 1 is limited, winning of the common bonus is notified to the other slot machines 1. Thereby, not only the player who won the common bonus not also the players of the other slot machines 1 and gallery can easily confirm on the upper liquid crystal display 3 or the lower liquid crystal display 4 when the coins pooled as the common bonus are got. As a result, concern of the player for the common bonus can be increased and interest for games can be raised. And notifying of winning of the common bonus can be conducted every each common bonus among a plurality of common bonuses, therefore it can be easily confirmed that coins for which of the common bonus are got.

Further, as mentioned, when the common bonus is won in the slot machine 1, the progressive unit 83 transmits to each slot machine 1 through the transmission control part 84 the coin pool information every each progressive bonus concerning with the bonus game, and such coin pool information is displayed on the upper liquid crystal display 3 in the slot machine 1. And if payout of coins for the common bonus which is won is determined, the common bonus (gold bar, jewelry, crown) concerning with the bonus game (bank bonus game, jewelry shop bonus game, royal museum bonus game) is selected and paid out. Therefore, even in the progressive gaming system 82 in which a plurality of common bonuses are installed, the player of the slot machine 1, the other players and gallery can confirm if there is a chance to be able to get which kind of the common bonus, thereby expectation for getting each common bonus and concern therewith can be increased and interest for games can be raised.

Further, as mentioned, difference is set in the coin pool number stored in the pool number storing part 86 every common bonus, thus if the bonus game concerning with the common bonus with high payout is done, expectation of the players for the common bonus in such bonus game is highly increased and modulation in games appears, as a result, interest for games can be highly maintained.

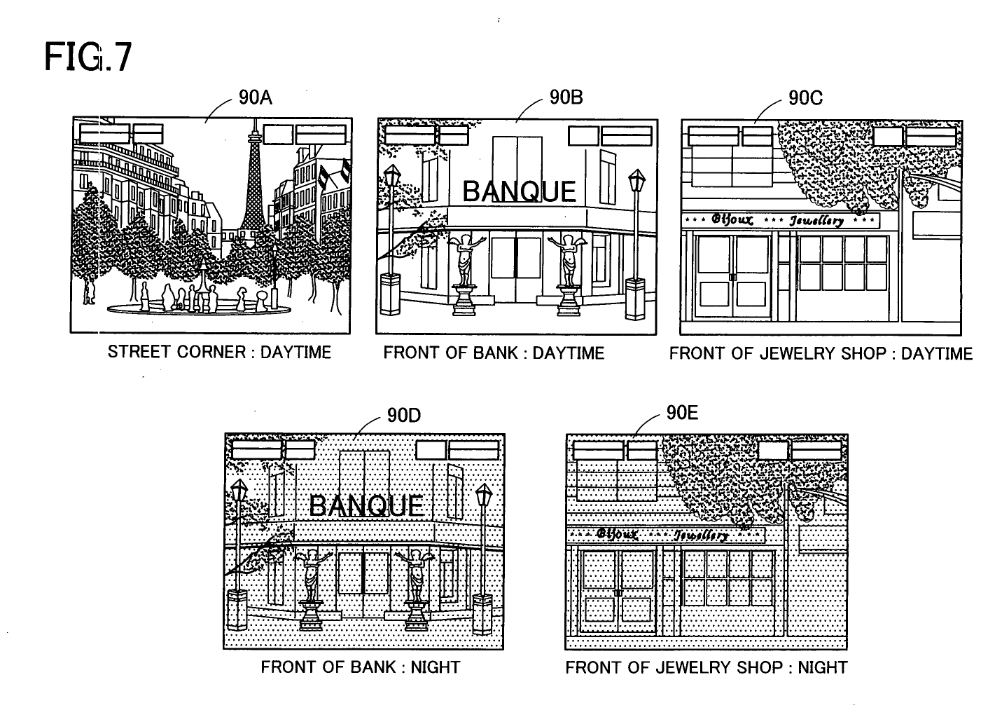

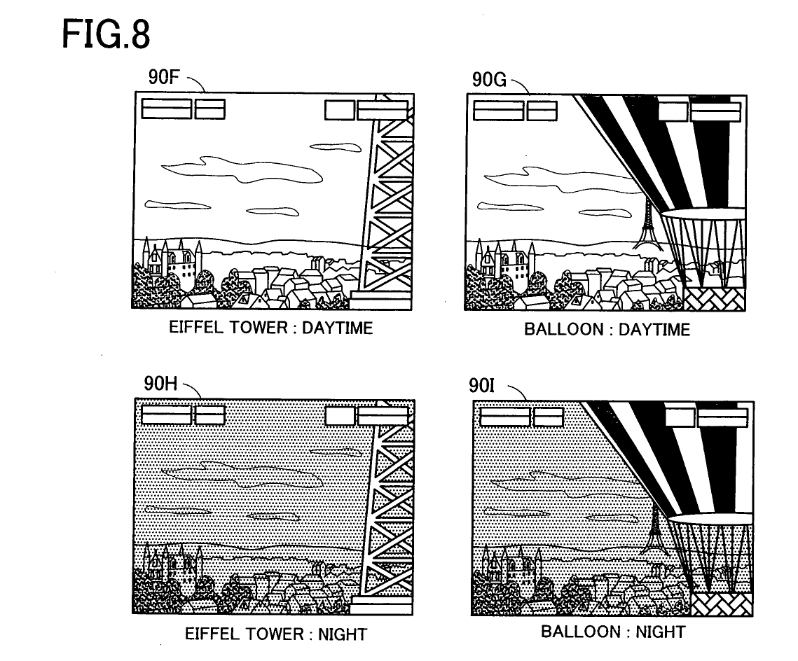

Here, for the sake of explanation described hereinafter, kinds of games and stratum construction in each game will be described with reference to FIGS. 7 to 14. FIGS. 7 and 8 are explanatory views schematically showing background images displayed on the lower liquid crystal display 4 when the base game is conducted,

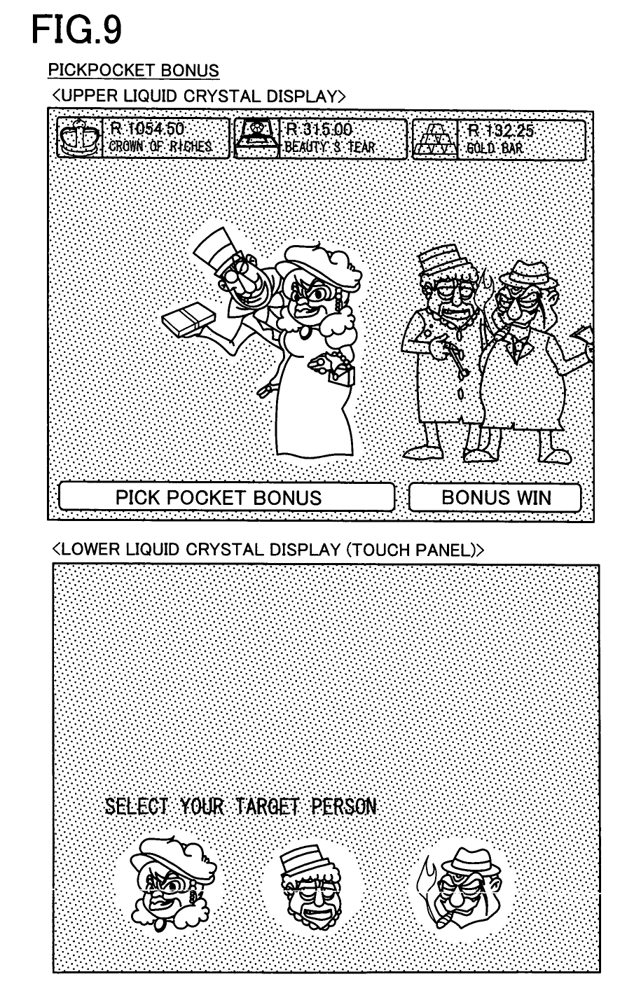

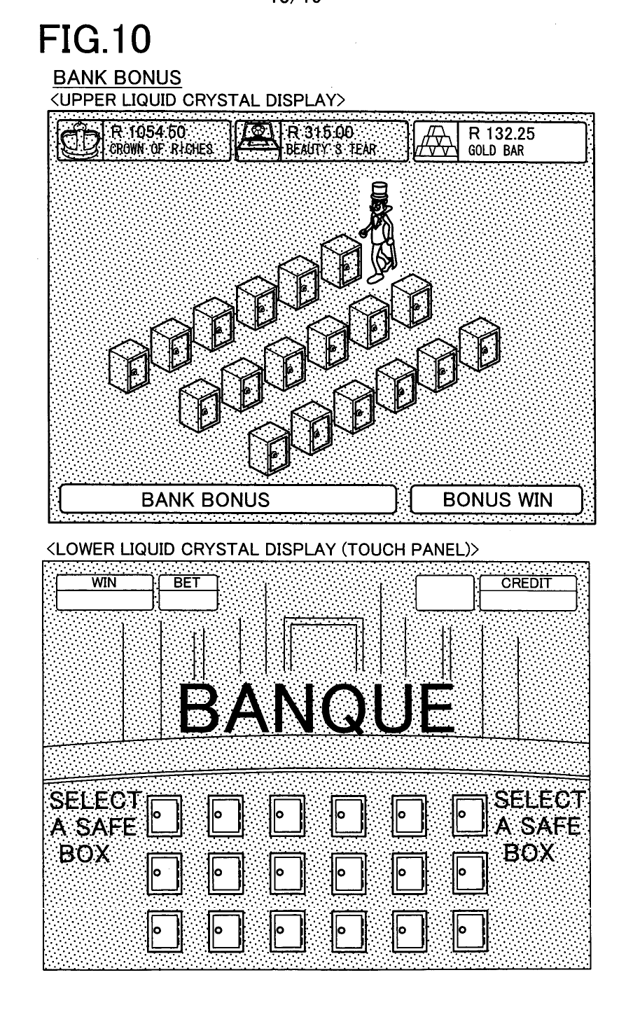

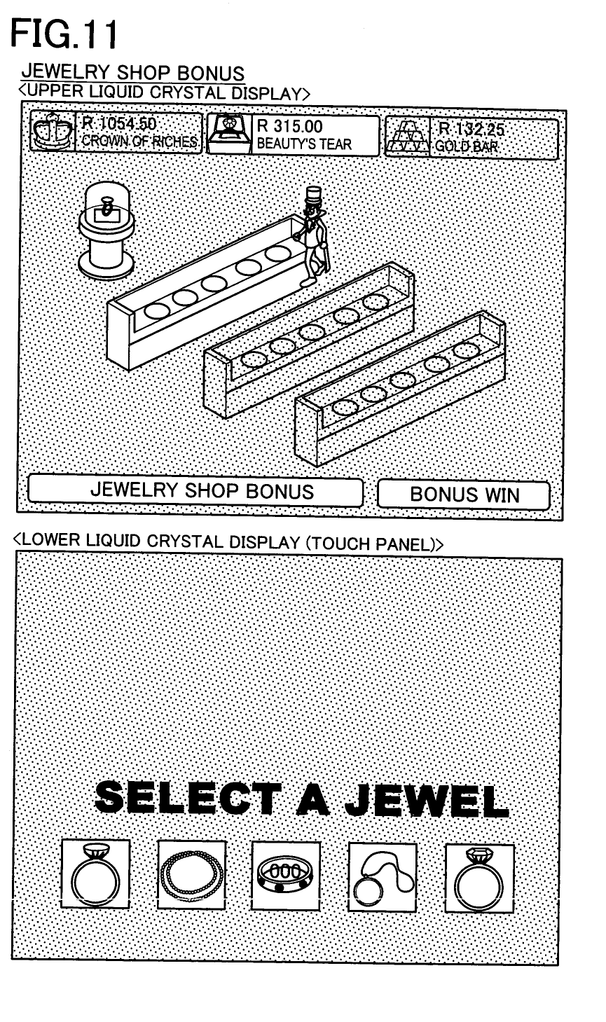

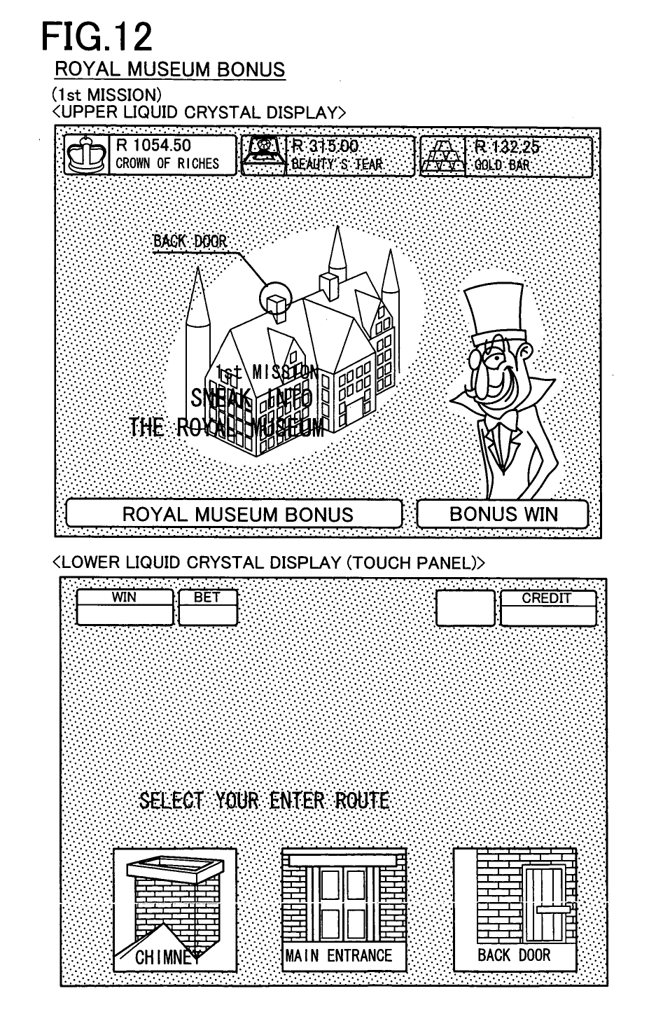

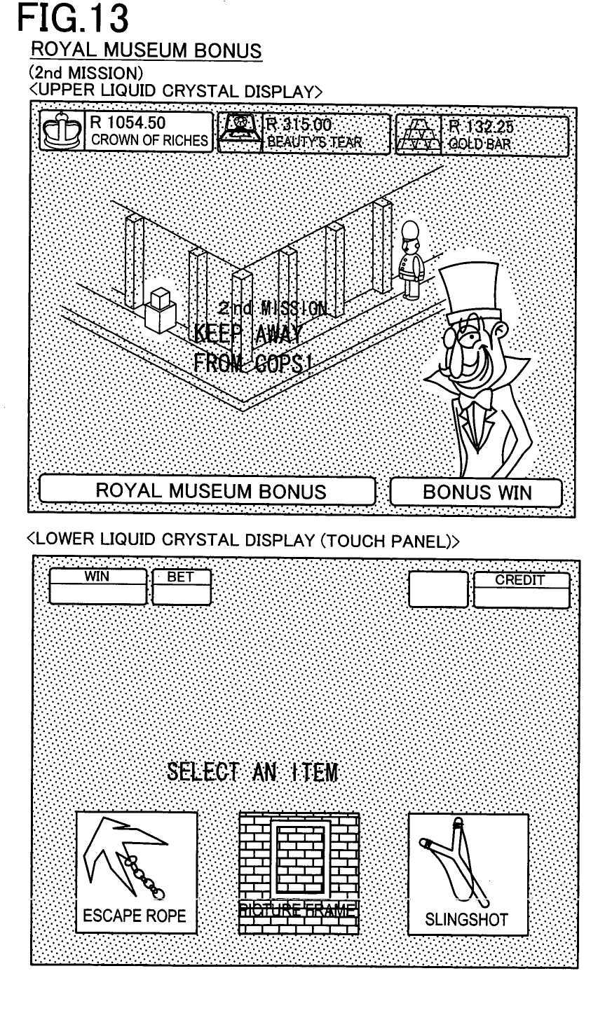

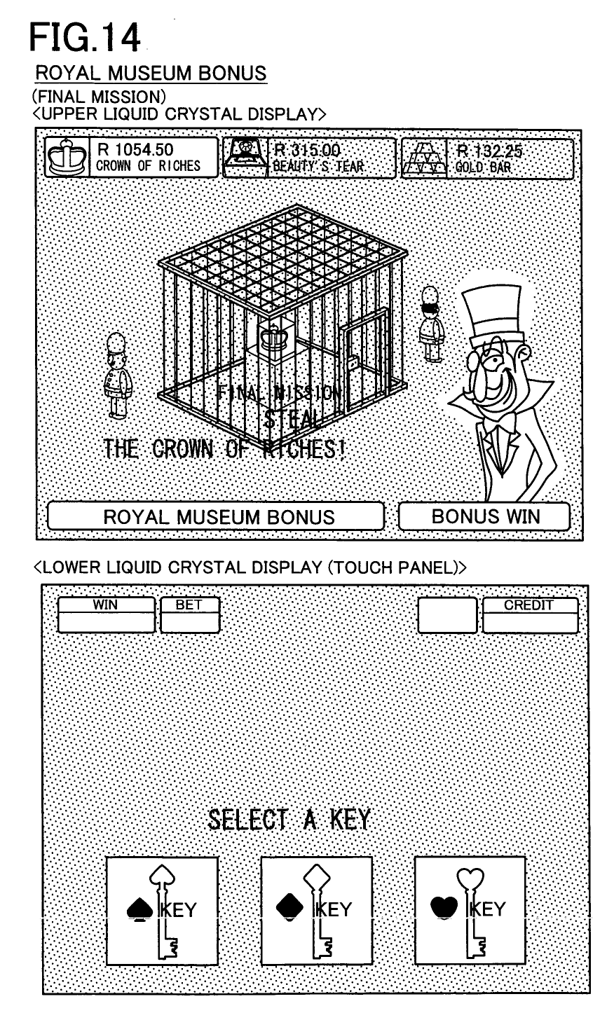

FIG. 9 is an explanatory view schematically showing background images displayed on the upper liquid crystal display 3 and the lower liquid crystal display 4 when the pickpocket bonus game is conducted, FIG. 10 is an explanatory view schematically showing background images displayed on the upper liquid crystal display 3 and the lower liquid crystal display 4 when the bank bonus game is conducted, FIG. 11 is an explanatory view schematically showing background images displayed on the upper liquid crystal display 3 and the lower liquid crystal display 4 when the jewelry shop bonus game is conducted. And FIGS. 12 to 14 are explanatory views schematically showing background images displayed on the upper liquid crystal display 3 and the lower liquid crystal display 4 when the royal museum bonus game is conducted. FIG. 12 is an explanatory view schematically showing background images displayed on the upper liquid crystal display 3 and the lower liquid crystal display 4 when the first mission of the royal museum bonus game is conducted, FIG. 13 is an explanatory view schematically showing background images displayed on the upper liquid crystal display 3 and the lower liquid crystal display 4 when the second mission of the royal museum bonus game is conducted, and FIG. 14 is an explanatory view schematically showing background images displayed on the upper liquid crystal display 3 and the lower liquid crystal display 4 when the final mission of the royal museum bonus game is conducted.

First, as the games conducted in the slot machine 1, there exist games roughly classified in the base game in which symbols on the reels 22 are stopped along the pay line L and the bonus game which is done based on that the trigger symbol formed on the outer periphery of the right reel 22 among three reels 22 is stopped on the pay line L in the base game. Here, if the progressive bonus is won based on selection of the player in the bonus game, payout of the progressive bonus is done.

As the background images displayed on the lower liquid crystal display 4 when the base games is conducted, as shown in FIGS. 7 and 8, there are nine images such as “street corner: daytime ” 91A, “front of bank: daytime” 90B, “from of jewelry shop: daytime” 90C, “front of bank: night” 90D, “front of jewelry shop: night” 90E, “Eiffel Tower: daytime” 90F, “balloon: daytime” 90G, “Eiffel Tower: night” 90H and “balloon: night” 90I. Each background image is successively displayed on the lower liquid crystal display 4. And in the slot machine 1, if the base game is started form one of the “street corner: daytime” 91A, “front of bank: daytime” 90B and “front of jewelry shop: daytime” 90C and the bonus game is won in the base game, the pickpocket bonus game is conducted. Here, based on the meaning of the “pickpocket”, in the pickpocket bonus game, it is constructed so as to select the target person who works as the pickpocket through the touch panel 30 attached to the front plane of the lower liquid crystal display 4, as shown i FIG. 9. According to this construction, there is a relation between the background image such as the “street corner: daytime” 91A, “front of bank: daytime” 90B and “front of jewelry shop: daytime” 90C displayed on the lower liquid crystal display 4 in the base game and the pickpocket bonus game conducted when the bonus game is won.

As mentioned, since the pickpocket bonus game is related to the background images such as the “street corner: daytime” 91A, “front of bank: daytime” 90B and “front of jewelry shop: daytime” 90C in the base game, the player can judge if there is a chance to shift to which kind of the bonus game, based on the effect information in the base game. Therefore, it can make the player have expectation for the bonus game while conducting the base game and interest of the player for games can be highly maintained.

Further, based on press of the SPIN/REPEAT button 12, if the base game is started from the background image of the “street corner: daytime” 91A and the effect to display fireworks is done, the trigger symbol formed on the outer periphery of the right reel 22 is stopped on the pay line L and the pickpocket bonus game is got. Similarly, based on press of the SPIN/REPEAT button 12, if the base game is started from the background image of the “front of bank: daytime” 90B and the effect to lighten stone statue is done, the trigger symbol formed on the outer periphery of the right reel 22 is stopped on the pay line L and the pickpocket bonus game is got. Further similarly, based on press of the SPIN/REPEAT button 12, if the base game is started from the background image of the “front of jewelry shop: daytime” 90C and the effect to lighten jewelry is done, the trigger symbol formed on the outer periphery of the right reel 22 is stopped on the pay line L and the pickpocket bonus game is got. As mentioned, while the base game is conducted, if the effect information with high expectation to shift to the pickpocket bonus game is displayed on the lower liquid crystal display 4, expectation of the player for the bonus game during the base game is increased, thereby modulation in games appears, as a result, games with high interest can be done.

Here, in the pickpocket bonus game, selection game to get the progressive bonus game is not set.

In the slot machine 1, if the base game is started from the background image of the “front of bank: night” 90D and the bonus game is got in the base game, the bank bonus game is conducted. Here, in the bank bonus game, as shown in FIG. 10, safes of 18 (3×6) are displayed on the upper liquid crystal display 3 and the lower liquid crystal display 4 and it is constructed to select the safe in which the gold bar exists through the touch panel 30 attached on the front plane of the lower liquid crystal display 4. As mentioned, there is a relation between the background image of the “front of bank: night” 90D displayed on the lower liquid crystal display 4 during the base game and the bank bonus game conducted when the bonus game is got.

As mentioned, since the bank bonus game is related to the background image of the “front of bank: night” 90D in the base game, the player can judge if there is a chance to shift to which kind of the bonus game, based on the effect information in the base game. Therefore, it can make the player have expectation for the bonus game while conducting the base game and interest of the player for games can be highly maintained.

Further, based on press of the SPIN/REPEAT button 12, if the base game is started from the background image of the “front of bank: night” 90D and the effect to lighten stone statue in front of the bank is done, the trigger symbol formed on the outer periphery of the right reel 22 is stopped on the pay line L and the bank bonus game is got. As mentioned, while the base game is conducted, if the effect information with high expectation to shift to the bank bonus game is displayed on the lower liquid crystal display 4, expectation of the player for the bonus game during the base game is increased, thereby modulation in games appears, as a result, games with high interest can be done.

Further, in the bank bonus game, the gold bar area displayed on the upper liquid crystal display 3 is emphasized and if the gold bar exists in the safe selected by the touch panel 30, the progressive bonus (gold bar) can be got. Thus, if the progressive bonus (gold bar) is got, it is notified to the other slot machines 1 that the progressive bonus (gold bar) is got. Concretely, the sentence such as “GOLD BAR WAS STOLEN” is displayed on the upper liquid crystal display 3 in the other slot machines 1.

In the slot machine 1, if the base game is started from the background image of the “front of jewelry shop: night” 90E and the bonus game is got in the base game, the jewelry shop bonus game is conducted. Here, in the jewelry shop bonus game, as shown in FIG. 11, the show window in the first row is displayed and emphasized on the upper liquid crystal display 3 and five jewels displayed in the emphasized show window are displayed on the lower liquid crystal display 4. Further, on the lower liquid crystal display 4, it is constructed to select one of the jewels through the touch panel 30 attached to the front plane of the lower liquid crystal display 4. And if the selected jewelry coincides with a jewelry which is determined beforehand by the lottery, the same procedure is conducted about five jewels displayed in the show window in the second row. If the selected jewelry of the show window in the second row coincides with a jewelry which is determined beforehand by the lottery, the same procedure is conducted about five jewels displayed in the show window in the third row. As mentioned, there is a relation between the background image of the “front of jewelry shop: night” 90E displayed on the lower liquid crystal display 4 during the base game and the jewelry shop bonus game conducted when the bonus game is got.

As mentioned, since the jewelry shop bonus game is related to the background image of the “front of jewelry shop: night” 90E in the base game, the player can judge if there is a chance to shift to which kind of the bonus game, based on the effect information in the base game. Therefore, it can make the player have expectation for the bonus game while conducting the base game and interest of the player for games can be highly maintained.

Further, based on press of the SPIN/REPEAT button 12, if the base game is started from the background image of the “front of jewelry shop: night” 90E and the effect to lighten jewelry is done, the trigger symbol formed on the outer periphery of the right reel 22 is stopped on the pay line L and the jewelry shop bonus game is got. As mentioned, while the base game is conducted, if the effect information with high expectation to shift to the jewelry shop bonus game is displayed on the lower liquid crystal display 4, expectation of the player for the bonus game during the base game is increased, thereby modulation in games appears, as a result, games with high interest can be done.

Further, in the jewelry shop bonus game, the beauty's tear area displayed on the upper liquid crystal display 3 is emphasized and if the predetermined jewels are selected in all show windows through the touch panel 30, concerning with the jewels existing in the show windows of the first row to the third row, the progressive bonus (beauty's tear) can be obtained. Thus, if the progressive bonus (beauty's tear) is got, it is notified to the other slot machines 1 that the progressive bonus (beauty's tear) is got. Concretely, the sentence such as “BEAUTY'S TEAR WAS STOLEN” is displayed on the upper liquid crystal display 3 in the other slot machines 1.

In the slot machine 1, if the base game is started from the background image of the “Eiffel Tower: daytime” 90F, “balloon: daytime” 90G, “Eiffel Tower: night” 90H and “balloon: night” 90I and the bonus game is got in the base game, the royal museum bonus game is conducted. Here, in the riyal museum bonus game, as shown in FIGS. 12 to 14, three stages of the first mission, the second mission and the final mission are prepared. In the first mission, as shown in FIG. 12, the royal museum is displayed on the upper liquid crystal display 3 and three invasion routes to invade in the royal museum are displayed on the lower liquid crystal display 4. And it is constructed to select one invasion route through the touch panel 30 attached to the front plane of the lower liquid crystal display 4. If the invasion route selected by the player coincides with an invasion route which is determined beforehand by the lottery, the procedure shifts to the second mission shown in FIG. 13. In the second mission, as shown in FIG. 13, the policeman standing on the corridor of the royal museum is displayed on the upper liquid crystal display 3 and three weapons for fighting with the policeman are displayed on the lower liquid crystal display 4. And it is constructed to select one of the weapons through the touch panel 30 attached to the front plane of the lower liquid crystal display 4. And if the selected weapon coincides with a weapon which is determined beforehand by the lottery, the procedure shifts to the final mission shown in FIG. 14. In the final mission, as shown in FIG. 14, the crown in the iron grid is displayed on the upper liquid crystal display 3 and three keys for opening the iron grid are displayed on the lower liquid crystal display 4. And it is constructed to select one key through the touch panel 30 attached to the front plane of the lower liquid crystal display 4. If the selected key selected by the player coincides with a key which is determined beforehand by the lottery, the iron grid is opened and the progressive bonus is got. As mentioned, there is a relation between the background image of the “Eiffel Tower: daytime” 90F, “balloon: daytime” 90G, “Eiffel Tower: night” 90H and balloon: night” 90I and the royal museum bonus game conducted when the bonus game is got.

As mentioned, since the royal museum bonus game is related to the background image of the “Eiffel Tower: daytime” 90F, “balloon: daytime” 90G, “Eiffel Tower: night” 90H and “balloon: night” 90I, the player can judge if there is a chance to shift to which kind of the bonus game, based on the effect information in the base game. Therefore, it can make the player have expectation for the bonus game while conducting the base game and interest of the player for games can be highly maintained.

Further, based on press of the SPIN/REPEAT button 12, if the base game is started from the background image of the “Eiffel Tower: daytime” 90F, “balloon: daytime” 90G, “Eiffel Tower: night” 90H and “balloon: night” 90I and the effect to display fireworks is done, the trigger symbol formed on the outer periphery of the right reel 22 is stopped on the pay line L and the royal museum bonus game is got. As mentioned, while the base game is conducted, if the effect information with high expectation to shift to the royal museum bonus game is displayed on the lower liquid crystal display 4, expectation of the player for the bonus game during the base game is increased, thereby modulation in games appears, as a result, games with high interest can be done.

Further, in the royal museum bonus game, as shown in FIGS. 12 to 14, the crown of riches area displayed on the upper liquid crystal display 3 is emphasized and if the predetermined invasion route, the predetermined weapon and the predetermined key are selected in the first mission, the second mission and the final mission are respectively selected through the touch panel 30 attached to the front plane of the lower liquid crystal display 4, the progressive bonus (crown of riches) can be got. Thus, if the progressive bonus (crown of riches) is got, it is notified to the other slot machines 1 that the progressive bonus (crown of riches) is got. Concretely, the sentence such as “CROWN OF RICHES WAS STOLEN” is displayed on the upper liquid crystal display 3 in the other slot machines 1.

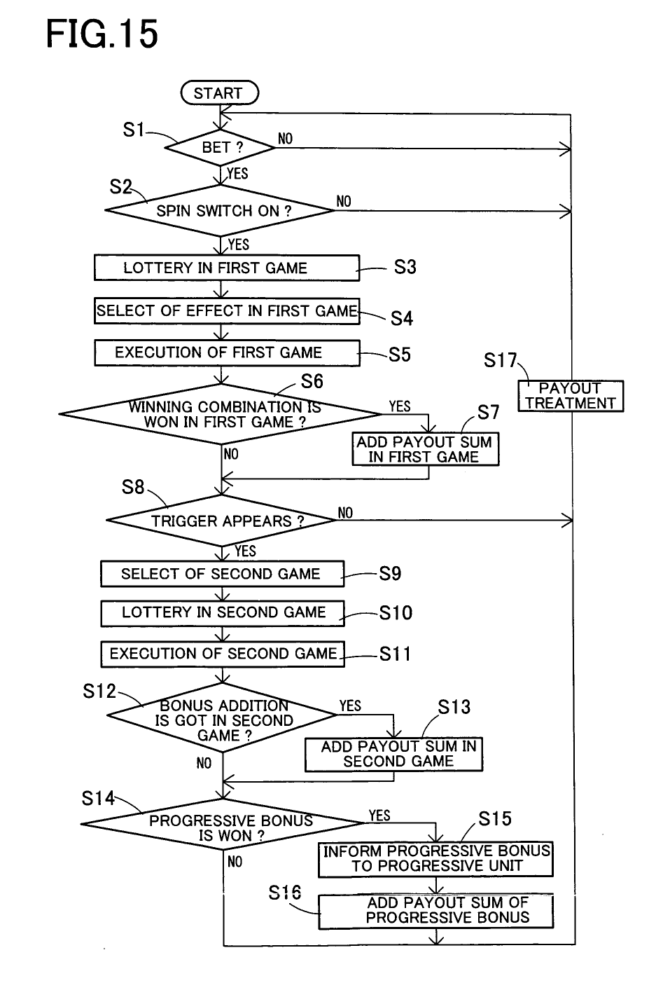

Next, game control procedures conducted in the above constructed slot machine 1 will be described with reference to FIG. 15. FIG. 15 is a flowchart showing the game control procedures conducted in the slot machine 1. Here, in the flowchart shown in FIG. 15, the base game is represented as the first game and the bonus game is represented as the second game.

In FIG. 15, when the slot machine 1 is powered on, it is judged in step 1 (abbreviated as S1 hereinafter) whether a predetermined bet number is betted or not by pressing the 1-BET button 11, the SPIN/REPEAT BET button 12, the 3-BET button 13 or 5-BET button 17. If the predetermined bet number is not betted (S1: NO), the procedure waits till the predetermined bet is betted. On the other hand, if it is judged that the predetermined bet number is betted (S1: YES), it is judged whether the spin switch 58 is turned on or not in S2. If it is judged that the SPIN/REPEAT BET button 12 is not pressed and the spin switch 58 is retained in off state (S2: NO), the procedure returns to S1. On the contrary, if it is judged that the spin switch 58 is turned on (S2: YES), the random number generated by the random number generator 55 is obtained by the random number sampling circuit 56. Further, based on the obtained random number and the lottery table stored in the ROM 51, it is conducted the lottery to determine: whether the wining combination is won or not; whether the trigger symbol existing on the right reel 22 should be stopped on the pay line L or not; and from which background image among nine images shown in FIGS. 8 and 9 the first game is started as the initial background image.

In S4, based on the initial background image of the first game determined in S3 by the lottery, the effect information is selected with reference to the effect tables of the first game stored in the ROM 51. In S5, the effect is started on the upper liquid crystal display 3 and the lower liquid crystal display 4 according to the effect information selected in S4 and each of three reels 22 is rotated and stopped by the motor drive circuit 67, each of the stepping motors 68 and the reel position detection circuit 69 under control by the CPU 50.

In S6, it is judged whether the winning combination is won or not based on the result of the lottery done in S3. If it is judged that the winning combination is not won (S6: NO), the procedure shifts to S8. On the contrary, if it is judged that the winning combination is won (S6: YES), the payout sum (coin number) corresponding to the winning combination in the first game is added in the RAM 52, thereafter the procedure shifts to S8.

In S8, it is judged whether the trigger symbol on the right reel 22 is stopped on the pay line L. If the trigger symbol is not stopped on the pay line L (S8: NO), the payout sum (coin number) in the first game added in S7 is paid out in S17, thereafter the procedure returns to S1. And if it is judged that the trigger symbol is stopped on the pay line L (S8: YES), the second game is selected in S9. At that time, as mentioned in the above, when the bonus game as the second game is selected, the bonus game is selected corresponding to the initial background image determined in S3 by the lottery. Concretely, if the initial background image in the first game is one of the “street corner: daytime” 91A, “front of bank: daytime” 90B and “front of jewelry shop: daytime” 90C, the pickpocket bonus game is selected as the second game. And if the initial background image in the first game is the “front of bank: night” 90D, the bank bonus game is selected as the second game. Further, if the initial background image in the first game is the “front of jewelry shop: night” 90E, the jewelry shop bonus game is selected as the second game. In addition, if the initial background image in the first game is one of the “Eiffel Tower: daytime” 90F, “balloon: daytime” 90G, “Eiffel Tower: night” 90H and “balloon: night” 90I, the royal museum bonus game is selected as the second game.

As mentioned, when the second game is selected, since the second game is selected in relation with the effect information of the first game, the player can judge if there is a chance to shift to which kind of the second game (bonus game), based on the effect information in the first game. Therefore, it can make the player have expectation for the second game while conducting the first game and interest of the player for games can be highly maintained

Next, in S10, all random elements necessary for progressing the second game are determined by the lottery. For example, if the second game selected in S9 is the pickpocket bonus game, the payout coin number is made different according to the person who is the target for pickpocket. And if the second game selected in S9 is the bank bonus game and the predetermined safes of the first row to the third row necessary for getting the progressive bonus are not selected, the payout coin number in such case is also determined according to the above lottery. Further, if the second game is the jewelry shop bonus game and the predetermined jewels in the show windows of the first row to the third row necessary for getting the progressive bonus are not selected, the payout coin number in such case is also determined according to the above lottery. In addition, if the second game is the royal museum bonus game and the predetermined invasion route in the first mission, the predetermined weapon in the second mission and the predetermined key in the final mission are not selected, the payout coin number in such case is also determined according to the above lottery.

In S11, the player selects various select objects through the touch panel 30 attached to the front plane of the lower liquid crystal display 4, thereby the second game is executed.

In S12, it is judged whether bonus addition of coins exists or not in the second game. If coins are not got in the second game, it is judged that the bonus addition does not exist (S12: NO). The procedure shifts to S14. On the other hand, if coins are got in the second game, it is judged that the bonus addition exists (S12: YES). Thereafter, in S13, the coin payout number got in the second game is added to the RAM 52 in which the coin number already got in the first game is stored. Thereafter, the procedure shifts to S14.

In S14, it is judged whether the progressive bonus is won or not. This judgement is done based on whether the predetermined select objects, which should be selected in each of the bank bonus game, the jewelry shop bonus game and the royal museum bonus game, are selected by the player.

If the progressive bonus is not won (S14: NO), the added coin number stored in the RAM 52 at that time is paid out in S17, thereafter the procedure shifts to S1. On the other hand, if it is judged that the progressive bonus is won (S14: YES), the progressive bonus is notified to the progressive unit 83 in S15. At that time, the progressive bonus which is won is related to the contents of the second game. Thereafter, in S16, the coin addition number corresponding to the progressive bonus is added to the RAM 52 in which the coin number already got in the first game and the coin number already got in the second game are stored. Thereafter, in S17, based on the coin payout number stored in the RAM 52, coin payout treatment is done. Thereafter, the procedure shifts to S1.

As mentioned in detail, since the bonus game is selected in relation to the effect information of the base game, the player can judge if there is a chance to shift to which kind of the bonus game, based on the effect information in the base game. Therefore, it can make the player have expectation for the bonus game while conducting the base game and interest of the player for games can be highly maintained.

Further, based on press of the SPIN/REPEAT button 12, in a case that the base game is started from various background images, the specific effect corresponding to the background image in the base game is conducted, thereby the trigger symbol formed on the outer periphery of the right reel 22 is stopped on the pay line L and various bonus games are got. Therefore, while the base game is conducted, if the effect information with high expectation to shift to various bonus games is displayed on the lower liquid crystal display 4, expectation of the player for the bonus game during the base game is increased, thereby modulation in games appears, as a result, games with high interest can be done.

And the coin pool number information concerning with the common bonus corresponding to each progressive bonus which is transmitted to each slot machine 1 from the progressive unit 83, is displayed on the lower liquid crystal display 4 of each slot machine 1, and based on this displayed information, the player can understand that the payout in the progressive bonus of the crown obtained in the royal museum bonus game is the highest, and the payout in the progressive bonus of the jewelry obtained in the jewelry shop bonus game follows to the progressive bonus of the crown in order of the payout, and further the payout in the progressive bonus of the gold bar obtained in the bank bonus game follows to the progressive bonus of the jewelry in order of the payout. Therefore, if the base game is started from one of the “Eiffel Tower: daytime” 90F, “balloon: daytime” 90G, “Eiffel Tower: night” 90H and “balloon: night” 90I, expectation for the progressive bonus of the crown which may be obtained in the royal museum bonus game is increased, thereby modulation in games appears, as a result, games with high interest can be done.

Further, in the progressive gaming system 82, the progressive unit 83 periodically transmits from the transmission control part 84 to each slot machine 1 the coin pool number information of each common bonus stored in the pool number storing part 86, and each slot machine 1 periodically compares the coin pool number information transmitted in previous time with the coin pool number information transmitted in present time, based on the coin pool number information transmitted from the progressive unit 83. And in a case that the coin pool number in present time reduces than the coin pool number in previous time, each slot machine 1 notifies that the common bonus in which the coin pool number reduces is won. Accordingly, even if the information transmitted from the progressive unit 83 to each slot machine 1 is limited, winning of the common bonus is notified to the other slot machines 1. Thereby, not only the player who won the common bonus not also the players of the other slot machines 1 and gallery can easily confirm on the upper liquid crystal display 3 or the lower liquid crystal display 4 when the coins pooled as the common bonus are got. As a result, concern of the player for the common bonus can be increased and interest for games can be raised. And notifying of winning of the common bonus can be conducted every each common bonus among a plurality of common bonuses, therefore it can be easily confirmed that coins for which of the common bonus are got.

Further, as mentioned, when the common bonus is won in the slot machine 1, the progressive unit 83 transmits to each slot machine 1 through the transmission control part 84 the coin pool information every each progressive bonus concerning with the bonus game, and such coin pool information is displayed on the upper liquid crystal display 3 in the slot machine 1. And if payout of coins for the common bonus which is won is determined, the common bonus (gold bar, jewelry, crown) concerning with the bonus game (bank bonus game, jewelry shop bonus game, royal museum bonus game) is selected and paid out. Therefore, even in the progressive gaming system 82 in which a plurality of common bonuses are installed, the player of the slot machine 1, the other players and gallery can confirm before the game in the slot machine 1 is finished if there is a chance to be able to get which kind of the common bonus, thereby expectation for getting each common bonus and concern therewith can be increased and interest for games can be raised.

Further, as mentioned, difference is set in the coin pool number stored in the pool number storing part 86 every common bonus, thus if the bonus game concerning with the common bonus with high payout is done, expectation of the players for the common bonus in such bonus game is highly increased and modulation in games appears, as a result, interest for games can be highly maintained.

Here, the above mentioned embodiment does not limit the present invention, therefore, of course, various improvements or modifications can be done within the scope of the present invention.

What is claimed is:

1. A gaming machine in which a base game is executed and a second game is executed continuous to the base game when a predetermined condition is realized, the gaming machine comprising:
a display device;
a memory for storing a plural kinds of effect information for the base game;
an effect information select device for selecting one effect information from the memory when the base game is executed;
a display control device for controlling the display device to display the effect information of the base game, the effect information being selected by the effect information select device;
a judgement device for judging whether the predetermined condition is realized or not; and
a game control device for selecting one second game from a plural kinds of the second games in relation to the effect information of the base game selected by the effect information select device when it is judged by the judgement device that the predetermined condition is realized and for executing the selected second game after the effect information of the base game is displayed on the display device by the display control device.

2. The gaming machine according to claim 1, wherein difference of expectation to shift to the second game is set among a plural kinds of the effect information of the base game.

3. The gaming machine according to claim 1, wherein difference of expectation is set among payouts each of which is obtained in each second game.

4. A gaming system including:
a plurality of gaming machines each of which selects one game among a plurality of games and executes the selected game; and
a control unit to which each gaming machine is connected, the control unit dividing a predetermined proportion of wager betted in each gaming machine by a predetermined ratio and accumulating each divided wager as a common bonus which has a relation to each game;
wherein the control unit controls a display device so as to display information concerning with the game conducted in the gaming machine and the common bonus, and
wherein the gaming machine pays out the common bonus based on that a specific condition corresponding to the game is realized.

5. The gaming system according to claim 4, wherein difference in payout of the common bonus is set among the common bonuses.

6. The gaming system according to claim 4, wherein the gaming machine comprises:
a receiving device for periodically receiving payout information of the common bonus from the control unit;
a comparison device for comparing the payout information received in a previous time through the receiving device with the payout information received in a present time through the receiving device; and
information device for notifying to the display device that the common bonus is won when the payout based on the payout information received in the present time reduces than the payout based on the payout information received in the previous time, according to a comparison result by the comparison device.

7. The gaming system according to claim 6, wherein a plurality of common bonuses are set in the control unit, and
wherein the comparison device compares the payout information received in the present time with the payout information received in the previous time every each common bonus.
